(19) United States
(12) Patent Application Publication
(10) Pub. No.: US 2012/0133294 A1
(43) Pub. Date: May 31, 2012

(54) LIGHT DIMMER AND METHOD

(75) Inventor: James A. Sutton, Statesville, NC (US)

(73) Assignee: PRO-TECH, INC., Statesville, NC (US)

(21) Appl. No.: 12/978,945

(22) Filed: Dec. 27, 2010

Related U.S. Application Data
(60) Provisional application No. 61/418,005, filed on Nov. 30, 2010.

(51) Int. Cl. H05B 41/36; H05B 41/16

(52) U.S. Cl. 315/209 R; 315/246

(57) ABSTRACT

A method for controlling an output of a AC current fluorescent lamp, including the steps of predetermining a desired degree of lamp illumination, determining the zero crossing point of a waveform representing an input voltage to the fluorescent lamp, and correlating the desired degree of illumination in relation to the zero crossing point and a cycle position later than the zero crossing point. Input voltage is allowed to flow to the fluorescent lamp beginning at zero voltage and an output feedback load is generated by the fluorescent lamp. The optimized input voltage is prevented from flowing to the fluorescent lamp after the zero crossing point at the correlated position of the input current in relation to the zero crossing point based on the detected output feedback load generated by the fluorescent lamp. A dimmer for carrying out the method is also disclosed.

### TECHNICAL FIELD AND BACKGROUND OF THE INVENTION

This invention relates to a light dimmer, and it characterized by permitting a light, for example, a fluorescent light, to be dimmed without flickering or shutting off entirely below a certain voltage—presently a problem in dimming fluorescent lights. This has particular importance because below a certain point in a conventionally-controlled fluorescent light the light will cease all illumination but yet continue to consume power. As more and more fluorescent lights are used, the ability to control light output without flicker, unnecessary power consumption or loss of lighting efficiency will become more important.

While the dimmer has use anywhere fluorescent lights are used, the invention and the preferred disclosure of the invention is described in this patent application in relation to raising poultry in large poultry enclosures. Moreover, the invention has application with many types of lamps, but it is believed that its primary use will be in connection with fluorescent lights, and therefore this application discloses the invention with particular relevance to fluorescent lighting products.

Typically, newly-hatched poultry are placed in a relatively bright environment. This stimulates feeding and increases growth rate during the early growth phase. Full illumination can also be easily provided to enable service personnel to service equipment in the poultry house. Later on, less light is provided, enabling the poultry to be less active, and making it easier for personnel to capture the poultry at the end of the growth cycle.

### SUMMARY OF THE INVENTION

Therefore, it is an object of the invention to provide a fluorescent light dimmer that enables fluorescent lights to be conveniently and efficiently dimmed as required for whatever light condition is desired.

These and other objects and advantages of the invention are achieved by providing a method of controlling light output of an AC current lamp, comprising the steps of predetermining a desired degree of lamp illumination, determining a zero crossing point of a waveform representing an input voltage to the lamp, and correlating the desired degree of illumination in relation to the zero crossing point and a cycle position later than the zero crossing point. Input voltage is allowed to flow to the lamp at the zero crossing point.

According to another embodiment of the invention, the method includes the steps of detecting an irregular quality of light based on electricity consumption of the lamp, and optimizing input voltage to flow to the lamp after the zero crossing point at the correlated position of the input current in relation to the zero crossing point based on the irregular quality of the light generated by the lamp.

According to another embodiment of the invention, the step of optimizing input voltage comprises the step of controlling flow of current with an IGBT device.

According to another embodiment of the invention, the AC current lamp is a fluorescent lamp.

According to another embodiment of the invention, the method includes the step of varying light output of the fluorescent lamp.

According to another embodiment of the invention, the AC current lamp is selected from the group consisting of CFL, CCF, LED, Fluorescent, LED lamps.

According to another embodiment of the invention, the method includes the step of raising the lamp to a desired degree of illumination gradually over a predetermined time interval.

According to another embodiment of the invention, the method includes the step of lowering the lamp to a desired degree of illumination gradually over a predetermined time interval.

According to another embodiment of the invention, the method includes the steps of monitoring the fluorescent lamp to determine a voltage at which an irregular quality of light output is incipient, and increasing the voltage just sufficiently to prevent the incipient irregular quality of light output.

According to an apparatus embodiment of the invention, an electronic apparatus for controlling light output of an AC current lamp is provided, comprising a controller for predetermining a desired degree of lamp illumination, a detector for determining a zero crossing point of a waveform representing an input voltage to the lamp, a correlation circuit for determining the desired degree of illumination in relation to the zero crossing point and a cycle position later than the zero crossing point, and a switch for allowing input voltage to flow to the lamp at the zero crossing point.

According to another embodiment of the invention, the apparatus includes a detector for detecting an irregular quality of light based on electricity consumption of the lamp; and an optimizing circuit for optimizing input voltage to flow to the lamp after the zero crossing point at the correlated position of the input current in relation to the zero crossing point based on the irregular quality of the light generated by the lamp.

According to another embodiment of the invention, the optimizing circuit controls the flow of current with an IGBT device.

According to another embodiment of the invention, the apparatus is adapted to control an AC fluorescent lamp.

According to another embodiment of the invention, the apparatus includes a circuit for raising the lamp to a desired degree of illumination gradually over a predetermined time interval.

According to another embodiment of the invention, the apparatus includes a circuit for lowering the lamp to a desired degree of illumination gradually over a predetermined time interval.

According to another embodiment of the invention, the apparatus monitors the fluorescent lamp to determine a voltage at which an irregular quality of light output is incipient, and increases the voltage just sufficiently to prevent the incipient irregular quality of light output.

According to another embodiment of the invention, the apparatus includes a controller for predetermining a desired degree of lamp illumination, a detector for determining a zero crossing point of a waveform representing an input voltage to the lamp, and a correlation circuit for determining the desired degree of illumination in relation to the zero crossing point and a cycle position later than the zero crossing point.

A switch allows input voltage to flow to the lamp at the zero crossing point, and a detector detects an irregular quality of light based on electricity consumption of the lamp. An IGBT optimizing circuit optimizes input voltage to flow to the lamp after the zero crossing point at the correlated position of the input current in relation to the zero crossing point based on the irregular quality of the light generated by the lamp.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is an AC waveform diagram showing the relationship between output voltage and the zero-crossing point;

FIG. 2 is an AC waveform diagram showing AC output in relation to a “glitch” detector;

FIG. 3 is a AC waveform where the load on a reverse phase dimmer is only an incandescent lamp or LED lamp;

FIG. 4 is a AC waveform where the load is a combination of an incandescent light and a fluorescent lamp;

FIGS. 5 and 6 illustrate the time delay between turn off of the voltage output and inductive feedback of a fluorescent lamp; and

FIG. 7 is a schematic diagram of the algorithm used to control the dimmer.

### DESCRIPTION OF THE PREFERRED EMBODIMENTS AND BEST MODE

This application relates to the detection of fluorescent lamps on a light dimmer in order to control the start-up voltage based on the type of load to extend the life of the lamps and optimize the performance of the dimmer based on the type of lamps used. Among the many different styles of electronic dimmers available, there are two basic types referred to as “leading edge” dimmer because the dimmer functions by removing the leading edge of the AC waveform. The second type is referred to as “trailing edge” dimmer (reverse phase) because the switching device must turn on as the AC waveform passes through zero, using a circuit called a zero-crossing detector. After a predetermined time set by the control, the switching device is turned off, and the remaining part of the waveform is not used by the load. Automatic detection of fluorescent lamps is not possible using a leading edge dimmer. However, using a trailing edge dimmer or reverse phase dimmer it has been observed that on turn off, after a short delay, there is a pulse generated from the feedback of an inductive load as represented by a fluorescent lamp. This feedback is not present when turning off the voltage on a resistive load, such as a non-inductive load as represented by incandescent lamps or LED lamps. This gives the ability to detect the type of load on a dimmer by locating and analyzing the output of the dimmer, to control the voltage to the load, optimize performance and extend the life of the fluorescent lamp.

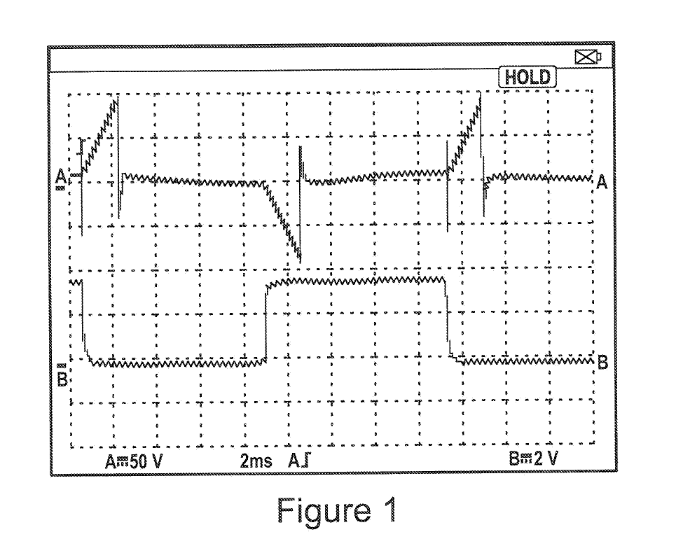

Referring now to FIG. 1, the graph shows the relationship of the output voltage with reference to the zero crossing of the input sine wave. Each edge of the ‘B’ waveform represents the zero crossing of the sine wave. As indicated by ‘A’ waveform in FIG. 1, the output is turned on at zero crossing and turned off at some time after the zero crossing to determine the output voltage.

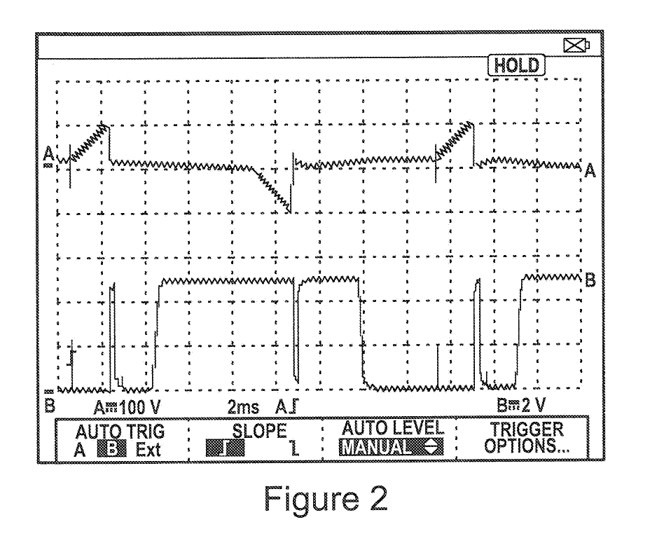

As indicated in FIG. 2, when a fluorescent load is applied to the output ('A′ waveform) of the reverse phase dimmer, a pulse is generated both on the positive slope and the negative slope of the sine wave at turn off ('B′ waveform) of the output voltage. This is due to inductive feedback of the fluorescent lamps. This pulse is delayed from the actual turn off of the output.

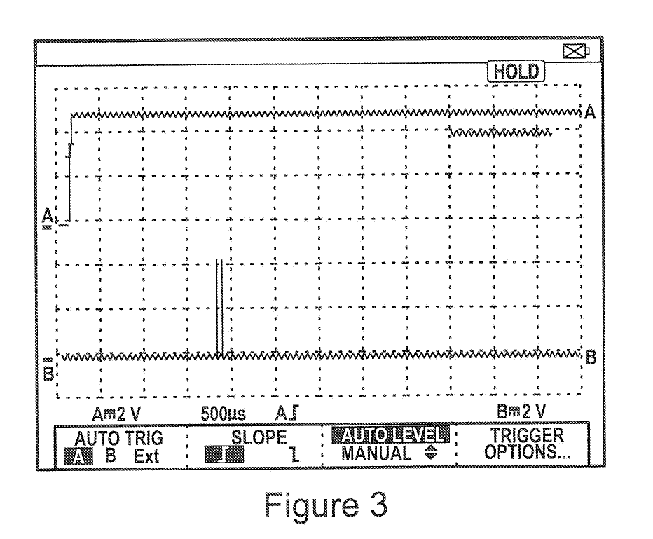

As shown in FIG. 3, this condition is not observed when using only incandescent lamps or an LED lamp as the load on a reverse phase dimmer. Waveform “A’ indicates the glitch detector while waveform ‘B’ shows the timing where the first pulse is the turn off of the voltage output and the second pulse indicates where the microprocessor is reading for the feedback.

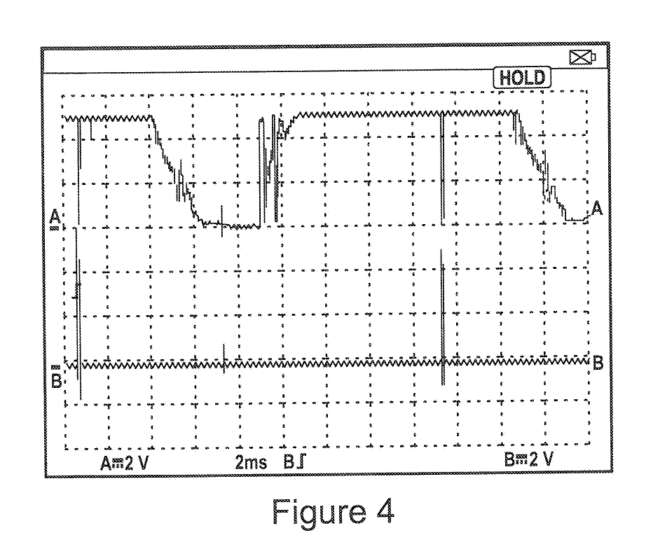

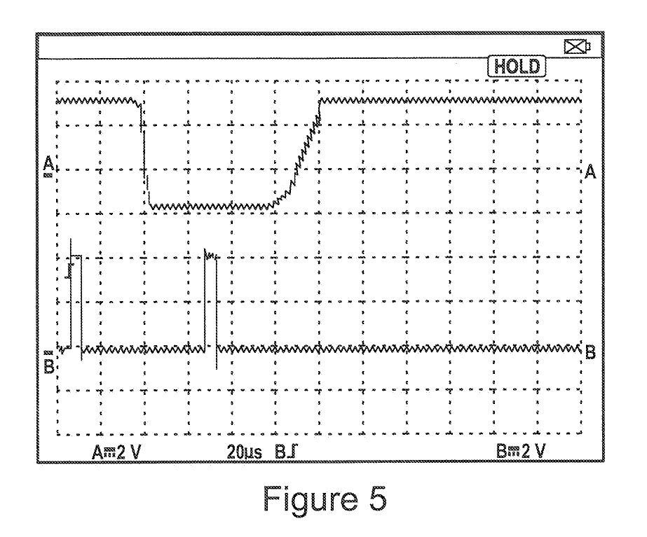

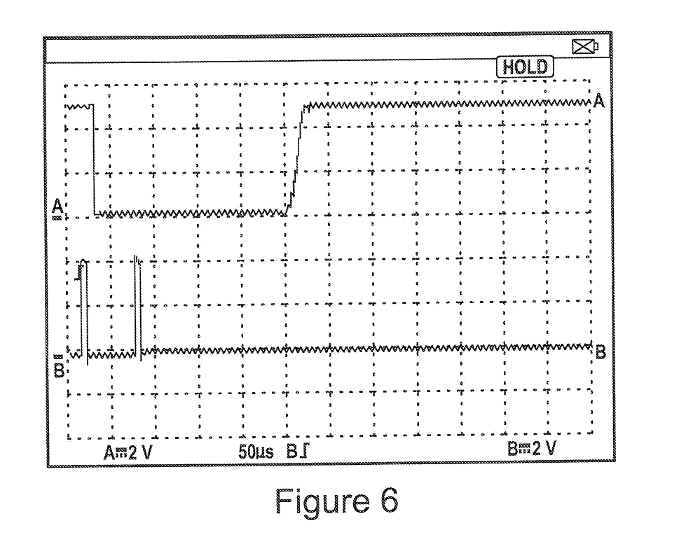

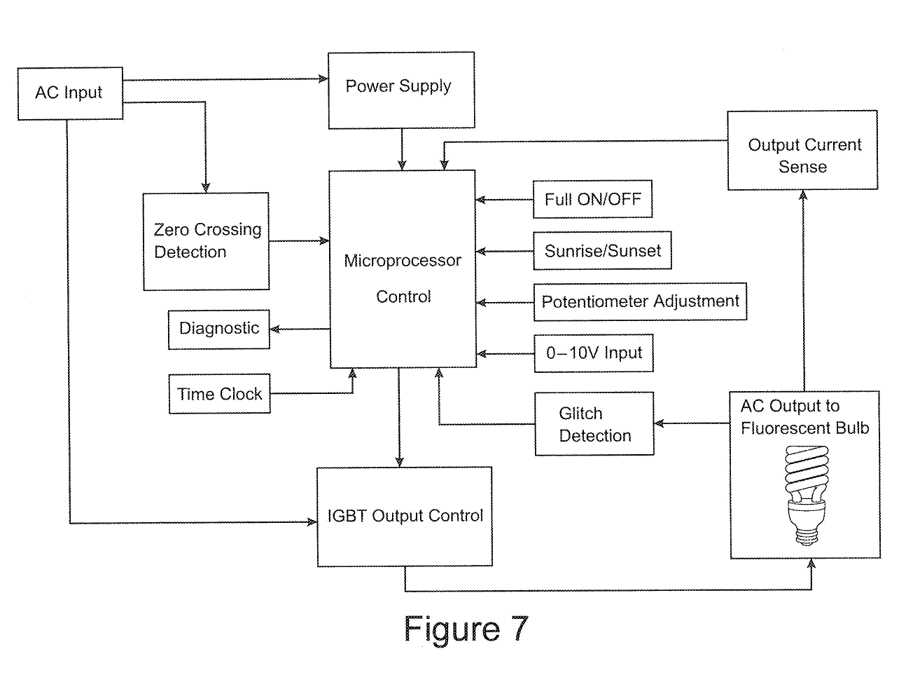

When both incandescent lamps and Fluorescent lamps are combined as a load on the output of the dimmer, the results are indicated as shown in FIG. 4, where the inductive feedback of the fluorescent lamps is indicated by waveform ‘A’. The time delay between the turn off of the voltage output and the inductive feedback is shown in FIGS. 5 and 6. The ‘A’ waveform is the glitch detector, and indicates the inductive feedback of the fluorescent lamps. The ‘B’ waveform indicates by the first pulse the turn off time of the voltage output and the second pulse, the state of the input by the microprocessor to detect the glitch. To accomplish detecting this feedback from the fluorescent lamps, it was necessary to create an algorithm in order to establish the correct timing. The algorithm starts with the zero crossing where the output is turned on, thus starting an event with a timer to determine the output voltage required. The second step is to turn off the output when the timer expires, giving an event that will start another timer in order to read the feedback of the inductive load. The timing of this is approximately sixty microseconds to the center of the feedback pulse, thus allowing reading the state of the glitch detector to determine if an inductive feedback is present or not.

Using the algorithm described above, it is possible to control the voltage output for startup on different loads to optimize the performance of the dimmer. On an incandescent lamp, it is acceptable to slowly increase the voltage from zero, thus allowing for full range from 0 to 120 VAC on the lamps. On fluorescent bulbs it is necessary to have the startup voltage begin at some point over the threshold of the electronic ballast in order not to have the lamps continuously turn on and off. This condition seriously compromises the life of the lamp and as a result should be eliminated. To accomplish this, it is necessary to determine the type of load on the dimmer to adjust the voltage above the threshold level when outputting the voltage to the lamps.

A semiconductor microprocessor is used to control the device, preferably, an insulated gate bipolar transistor, or “IGBT.” An IGBT is a three-terminal power semiconductor device, noted for high efficiency and fast switching. It switches electric power in many modern appliances, such as electric cars, trains, variable speed refrigerators, air-conditioners and even stereo systems with switching amplifiers. Since it is designed to rapidly turn on and off, amplifiers that use it often synthesize complex waveforms with pulse width modulation and low-pass filters. The IGBT combines the simple gate-drive characteristics of the MOSFETs with the high-current and low-saturation-voltage capability of bipolar transistors by combining an isolated gate FET for the control input, and a bipolar power transistor as a switch, in a single device. The IGBT is used in medium- to high-power applications such as switched-mode power supply, traction motor control and induction heating and is therefore ideal for the application described in this application.

The dimmer is a 2000 watt, reverse phase light dimmer that provides a soft start at every half-cycle, and 98+ percent increased noise immunity. The IGBT switches on at every zero crossing, and is turned off at some point in the cycle depending on the degree of dimming desired. This switching occurs rapidly (60 Hz, 8.3 milliseconds) and is the electronic basis for dimming the lamp.

The dimmer preferably has a 16 amp output with both a toggle switch for full off-and-on control, and a rotatable dimmer switch. A zero to 10 volt input is provided if the dimmer is to be operated by a controller. A knob is provided for manual dimming, which is deactivated when the zero to 10 volt input is used. The dimmer will properly control a large variety of fluorescent lamps, including Retrolite 15 and 23 watt lamps, dim CFL's and Overdrive 8 and 15 cold cathodes.

The dimmer is operated at 120 Volts, 50 to 65 Hz. Use of the IGBT improves generator performance. A “sunrise-sunset” feature is provided that allows “soft on” and “soft off” illumination over a near-zero to 20 minute interval. Dimmable fluorescent lamps have a range where they perform optimally. This optimal range is increased using the dimmer described in this application, but at very low levels the fluorescent lamp may nevertheless flicker or cease illumination altogether. In this condition, the dimmer uses a feedback circuit to “watch” the lamp, so that when this point is reached, the voltage is increased slightly—just enough to maintain the bulb at its lowest intensity without compromising the life of the bulb.

An overload prevention circuit limits output to 2000+10% watts in order to prevent overloads, spikes and similar undesirable effects. Because the dimmer turns on the load at zero crossing rather than turning off the load at zero crossing, a very high degree of noise immunity—on the order of 98 percent—is available. The dimmer also creates less noise. Noise immunity and the above-mentioned soft-on, soft-off feature increase lamp life significantly.

While intended principally for fluorescent lamps, it is usable with many types of lamps, including CFL, CCF, LED, Incandescent and many others.

An improved dimmer is described above. Various details of the invention may be changed without departing from the scope of the invention. Furthermore, the foregoing description of the preferred embodiment of the invention and best mode for practicing the invention are provided for the purpose of illustration only and not for the purpose of limitation, the invention being defined by the claims.

I claim:

1. A method of controlling light output of an AC current lamp, comprising the steps of:
(a) predetermining a desired degree of lamp illumination;
(b) determining a zero crossing point of a waveform representing an input voltage to the lamp;
(c) correlating the desired degree of illumination in relation to the zero crossing point and a cycle position later than the zero crossing point; and
(d) allowing input voltage to flow to the lamp beginning at the zero crossing point.

2. A method according to claim 1, and including the steps of:
(a) detecting an irregular quality of light based on electricity consumption of the lamp; and
(b) optimizing input voltage to flow to the lamp after the zero crossing point at the correlated position of the input current in relation to the zero crossing point based on the irregular quality of the light generated by the lamp.

3. A method according to claim 2, wherein the step of optimizing input voltage comprises the step of controlling flow of current with an IGBT device.

4. A method according to claim 2, wherein the AC current lamp is a fluorescent lamp.

5. A method according to claim 4, and including the step of varying light output of the fluorescent lamp.

6. A method according to claim 1, wherein the AC current lamp is selected from the group consisting of CFL, CCF, LED, fluorescent, incandescent and LED lamps.

7. A method according to claim 2, and including the step of raising the lamp to a desired degree of illumination gradually over a predetermined time interval.

8. A method according to claim 2, and including the step of lowering the lamp to a desired degree of illumination gradually over a predetermined time interval.

9. A method according to claim 4, and including the steps of monitoring the fluorescent lamp to determine a voltage at which an irregular quality of light output is incipient, and increasing the voltage just sufficiently to prevent the incipient irregular quality of light output.

10. An electronic apparatus for controlling light output of an AC current lamp, comprising:
(a) a controller for predetermining a desired degree of lamp illumination;
(b) a detector for determining a zero crossing point of a waveform representing an input voltage to the lamp;
(c) a correlation circuit for determining the desired degree of illumination in relation to the zero crossing point and a cycle position later than the zero crossing point; and
(d) a switch for allowing input voltage to flow to the lamp at the zero crossing point.

11. An apparatus according to claim 10, and including a detector for detecting an irregular quality of light based on electricity consumption of the lamp; and an optimizing circuit for optimizing input voltage to flow to the lamp after the zero crossing point at the correlated position of the input current in relation to the zero crossing point based on the irregular quality of the light generated by the lamp.

12. An apparatus according to claim 11, wherein the optimizing circuit controls the flow of current with an IGBT device.

13. An apparatus according to claim 12, wherein the apparatus is adapted to control an AC fluorescent lamp.

14. An apparatus according to claim 12, and including the step of raising the lamp to a desired degree of illumination gradually over a predetermined time interval.

15. An apparatus according to claim 12, wherein the IGBT is programmed to lower the lamp to a desired degree of illumination gradually over a predetermined time interval.

16. An apparatus according to claim 12, wherein the wave form at the IGBT monitors the fluorescent lamp to determine a voltage at which an irregular quality of light output is incipient, and increases the voltage just sufficiently to prevent the incipient irregular quality of light output.

17. An electronic apparatus for controlling light output of an AC current fluorescent lamp, comprising:
(a) a controller for predetermining a desired degree of lamp illumination;
(b) a detector for determining a zero crossing point of a waveform representing a beginning input voltage to the lamp;
(c) a correlation circuit for determining the desired degree of illumination in relation to the zero crossing point and a cycle position later than the zero crossing point;
(d) a switch for allowing input voltage to flow to the lamp beginning at the zero crossing point;
(e) a detector for detecting an irregular quality of light based on electricity consumption of the lamp; and
(f) an IGBT optimizing circuit for optimizing input voltage to flow to the lamp after the zero crossing point at the correlated position of the input current in relation to the zero crossing point based on the irregular quality of the light generated by the lamp.
